(19) United States
(12) Patent Application Publication
(10) Pub. No.: US 2020/0307079 A1
(43) Pub. Date: Oct. 1, 2020

(54) ADDITIVE MANUFACTURING APPARATUS AND ADDITIVE MANUFACTURING METHOD

(71) Applicant: SINTOKOGIO, LTD., Nagoya-shi (JP)

(72) Inventors: Kouji KAJITA, Toyokawa-shi (JP); Kazuya KOJIMA, Toyokawa-shi (JP); Takaya NAKANE, Toyokawa-shi (JP)

(73) Assignee: SINTOKOGIO, LTD., Nagoya-shi (JP)

(21) Appl. No.: 16/826,930

(22) Filed: Mar. 23, 2020

(30) Foreign Application Priority Data
Mar. 29, 2019 (JP) 2019-067289

(51) Int. Cl. B29C 64/188; B29C 64/241; B29C 64/264; B29C 64/30; B29C 64/255

(52) U.S. Cl. CPC B29C 64/188; B29C 64/241; B33Y 30/00; B29C 64/30; B29C 64/255; B29C 64/264

(57) ABSTRACT

An additive manufacturing apparatus includes a cylindrical rotating body, a rotation drive unit causing the rotating body to rotate around an axis of rotation, a supply unit provided above the rotating body and supplying slurry containing ultraviolet light curable resin to a top surface of the rotating body during rotation of the rotating body, a flattening unit provided above the rotating body, located downstream of the supply unit and flattening the slurry supplied to the top surface of the rotating body at an end portion thereof during rotation of the rotating body, a relative drive unit relatively moving the rotating body with respect to the supply unit and the flattening unit, and an irradiation unit provided above the rotating body, located downstream of the flattening unit in the rotating direction of the rotating body and performing spot-irradiation with ultraviolet light at an irradiation position during rotation of the rotating body.

### CROSS-REFERENCE TO RELATED APPLICATION

This application is based on Japanese Patent Application No. 2019-067289 filed with Japan Patent Office on Mar. 29, 2019, the entire contents of which are hereby incorporated by reference.

### TECHNICAL FIELD

The present disclosure relates to an additive manufacturing apparatus and an additive manufacturing method.

### BACKGROUND

Japanese Unexamined Patent Publication No. 2016-203425 describes a manufacturing method for manufacturing a three-dimensional molded object by lamination. In this method, a layer forming unit forms a layer on a stage and the layer is cured using binding liquid application means and ultraviolet light irradiating means. The layer forming unit, the binding liquid application means and the ultraviolet light irradiating means move above the stage in a horizontal direction.

### SUMMARY

Here, the respective components such as the layer forming unit, the binding liquid application means and the ultraviolet light irradiation means in Japanese Unexamined Patent Publication No. 2016-203425 need to move above the stage in order. After movement and processing of each component are completed, the stage needs to descend for lamination. For this reason, since neither each component can move above the stage in parallel nor the stage can descend in parallel with the movement of each component, it may take time to obtain a molded object.

The present disclosure provides an additive manufacturing apparatus and an additive manufacturing method capable of improving a manufacturing speed of a molded object.

An additive manufacturing apparatus according to an aspect of the present disclosure is an additive manufacturing apparatus forming a molded object layer by layer, comprising a cylindrical rotating body having an axis of rotation in a direction along a center line thereof, a rotation drive unit causing the rotating body to rotate around the axis of rotation, a supply unit provided above the rotating body and supplying slurry containing ultraviolet light curable resin to a top surface of the rotating body during rotation of the rotating body by the rotation drive unit, a flattening unit provided above the rotating body, located downstream of the supply unit in the rotating direction of the rotating body and flattening the slurry supplied to the top surface of the rotating body at an end portion thereof to a thickness corresponding to one layer during rotation of the rotating body by the rotation drive unit, a relative drive unit relatively moving the rotating body with respect to the supply unit and the flattening unit in the direction along the center line of the rotating body, and an irradiation unit provided above the rotating body, located downstream of the flattening unit in the rotating direction of the rotating body and performing spot-irradiation with ultraviolet light at an irradiation position determined based on a shape of the molded object during rotation of the rotating body by the rotation drive unit.

In the additive manufacturing apparatus, the rotating body is rotated around the axis of rotation by the rotation drive unit. During rotation of the rotating body, slurry is supplied to the top surface of the rotating body by the supply unit. The slurry is flattened by the flattening unit downstream of the supply unit in the rotating direction of the rotating body. The slurry is irradiated with ultraviolet light by the irradiation unit downstream of the flattening unit in the rotating direction of the rotating body. The supply unit, the flattening unit and the rotating body are relatively moved by the relative drive unit in a direction along the center line of the rotating body. In this way, since the top surface of the rotating body moves with respect to the supply unit, the flattening unit and the irradiation unit, the supply unit, the flattening unit and the irradiation unit need not move in a circumferential direction. Therefore, the supply unit, the flattening unit and the irradiation unit can execute processing without waiting for movement of each component to be completed and can form layers of the molded object continuously. Moreover, the relative drive unit allows the rotating body to move relatively with respect to the supply unit and the flattening unit without waiting for processing of each component to be completed. This allows the additive manufacturing apparatus to shorten time to wait for the movement or processing of each component to be completed. Thus, according to this additive manufacturing apparatus, the manufacturing speed of the molded object can be improved.

In the embodiment, the irradiation unit may complete irradiation corresponding to one layer of the molded object after irradiation with ultraviolet light starts until the rotating body makes one rotation based on the rotation speed of the rotating body by the rotation drive unit and the irradiation position. In this way, the additive manufacturing apparatus can perform processing continuously at the supply unit, the flattening unit and the irradiation unit, and can thereby improve a manufacturing speed of the molded object.

In the embodiment, the irradiation unit may change the position of an irradiation point of ultraviolet light based on the rotation speed of the rotating body by the rotation drive unit and the irradiation position for every rotation of the rotating body along the radial direction of the rotating body and complete irradiation corresponding to one layer of the molded object. In this case, the irradiation unit may not change the position of the irradiation point of ultraviolet light to the radial direction of the rotating body according to the irradiation position after irradiation with ultraviolet light starts until the rotating body makes one rotation. This allows the additive manufacturing apparatus to reduce the time required to change the position of irradiation point of ultraviolet light by the irradiation unit.

An additive manufacturing apparatus according to another aspect of the present disclosure is an additive manufacturing apparatus forming a molded object layer by layer, comprising a cylindrical rotating body having an axis of rotation in a direction along a center line thereof, a rotation drive unit causing the rotating body to rotate around the axis of rotation, a supply unit provided outside the rotating body and supplying slurry containing ultraviolet light curable resin to an outer circumferential surface of the rotating body during rotation of the rotating body by the rotation drive unit, a first drive unit moving the supply unit along a radial direction of the rotating body, a flattening unit provided outside the rotating body, located downstream of the supply unit in the rotating direction of the rotating body and flattening the slurry supplied to the outer circumferential surface of the rotating body at an end portion thereof to a thickness corresponding to one layer during rotation of the rotating body by the rotation drive unit, a second drive unit moving the flattening unit along the radial direction of the rotating body, and an irradiation unit provided outside the rotating body, located downstream of the flattening unit in the rotating direction of the rotating body and performing spot-irradiation with ultraviolet light at an irradiation position determined based on a shape of the molded object during rotation of the rotating body by the rotation drive unit.

In this additive manufacturing apparatus, the rotation drive unit causes the rotating body to rotate around the axis of rotation. During rotation of the rotating body, slurry is supplied to the outer circumferential surface of the rotating body by the supply unit. The slurry is flattened by the flattening unit downstream of the supply unit in the rotating direction of the rotating body. The slurry is irradiated with ultraviolet light downstream of the flattening unit in the rotating direction of the rotating body by the irradiation unit. The supply unit moves in a direction along the radial direction of the rotating body by the first drive unit. The flattening unit moves in the direction along the radial direction of the rotating body by the second drive unit. In this way, since the outer circumferential surface of the rotating body moves with respect to the supply unit, the flattening unit and the irradiation unit, the supply unit, the flattening unit and the irradiation unit need not move in the circumferential direction of the rotating body. Therefore, the supply unit, the flattening unit and the irradiation unit can execute processing without waiting for the movement of each component to be completed and can form layers of the molded object continuously. Moreover, the supply unit and the flattening unit can move by the first drive unit and the second drive unit at a time at which the processing by each component is completed without waiting for the processing by other components to be completed. This allows the additive manufacturing apparatus to shorten time to wait for the movement or processing of each component to be completed. Thus, according to this additive manufacturing apparatus, the manufacturing speed of the molded object can be improved.

In the embodiment, the irradiation unit may complete irradiation corresponding to one layer of the molded object after irradiation with ultraviolet light starts until the rotating body makes one rotation based on the rotation speed of the rotating body by the rotation drive unit and the irradiation position. Thus, the additive manufacturing apparatus can execute the respective processes by the supply unit, the flattening unit and the irradiation unit continuously, and can thereby improve the manufacturing speed of the molded object.

In the embodiment, the irradiation unit may change the position of the irradiation point of ultraviolet light based on the rotation speed of the rotating body by the rotation drive unit and the irradiation position for every rotation of the rotating body along a center line of the rotating body and complete irradiation corresponding to one layer of the molded object. In this case, the irradiation unit may not change the position of the irradiation point of ultraviolet light to the direction along the center line of the rotating body according to the irradiation position after irradiation with ultraviolet light starts until the rotating body makes one rotation. This allows the additive manufacturing apparatus to reduce the time required to change the position of the irradiation point of ultraviolet light at the irradiation unit.

An additive manufacturing method according to a further aspect of the present disclosure is an additive manufacturing method forming a molded object layer by layer, comprising a step of rotating a cylindrical rotating body having an axis of rotation in a direction along a center line thereof around the axis of rotation, a step of supplying slurry containing ultraviolet light curable resin to a top surface of the rotating body during rotation of the rotating body, a step of flattening the slurry supplied to the top surface of the rotating body in the step of supplying to a thickness corresponding to one layer and a step of spot-irradiating the slurry flattened on the top surface of the rotating body in the step of flattening with ultraviolet light at an irradiation position determined based on a shape of the molded object during rotation of the rotating body.

According to this additive manufacturing method, in the step of rotating, the rotating body rotates around the axis of rotation. In the step of supplying, the slurry is supplied to the top surface of the rotating body during rotation of the rotating body. In the step of flattening, the supplied slurry is flattened to a thickness corresponding to one layer during rotation of the rotating body. In the step of irradiating, the flattened slurry is irradiated with ultraviolet light during rotation of the rotating body. Thus, since the top surface of the rotating body moves with respect to the position at which the slurry is supplied in the step of supplying, the position at which the slurry is flattened in the step of flattening and the position at which ultraviolet light is radiated in the step of irradiating, a configuration need not be adopted in which each position moves in the circumferential direction. For this reason, in each step, it is possible to form layers of the molded object continuously without changing the position of processing in each step. In this way, the present additive manufacturing method can shorten the time to wait for completion of movement or processing of each component. Thus, according to the present additive manufacturing method, it is possible to improve the manufacturing speed of the molded object.

An additive manufacturing method according to a still further aspect of the present disclosure is an additive manufacturing method forming a molded object layer by layer, comprising a step of rotating a cylindrical rotating body having an axis of rotation in a direction along a center line thereof around the axis of rotation, a step of supplying slurry containing ultraviolet light curable resin to an outer circumferential surface of the rotating body during rotation of the rotating body, a step of flattening the slurry supplied to the outer circumferential surface of the rotating body in the step of supplying to a thickness corresponding to one layer, and a step of spot-irradiating the slurry flattened on the outer circumferential surface of the rotating body in the step of flattening with ultraviolet light at an irradiation position determined based on a shape of the molded object during rotation of the rotating body.

According to the present additive manufacturing method, in the step of rotating, the rotating body rotates around the axis of rotation. In the step of supplying, the slurry is supplied to the outer circumferential surface of the rotating body during rotation of the rotating body. In the step of flattening, the supplied slurry is flattened to a thickness corresponding to one layer during rotation of the rotating body. In the step of irradiating, the flattened slurry is irradiated with ultraviolet light during rotation of the rotating body. Thus, since the outer circumferential surface of the rotating body moves with respect to the position at which the slurry is supplied in the step of supplying, the position at which the slurry is flattened in the step of flattening and the position at which ultraviolet light is radiated in the step of irradiating, a configuration need not be adopted in which each position moves in the circumferential direction of the rotating body. For this reason, in each step, it is possible to form layers of a molded object continuously without changing the position of processing in each step. In this way, the present additive manufacturing method can shorten the time to wait for completion of movement or processing of each component. Thus, according to the present additive manufacturing method, it is possible to improve the manufacturing speed of the molded object.

The additive manufacturing apparatus and the additive manufacturing method according to the present disclosure can improve the manufacturing speed of the molded object.

### BRIEF DESCRIPTION OF THE DRAWINGS

FIG. 1 is a schematic view illustrating an example of an additive manufacturing apparatus according to a first embodiment;

FIG. 2 is a block diagram illustrating an example of a controller of the additive manufacturing apparatus according to the first embodiment;

FIG. 3 is a flowchart illustrating an example of an additive manufacturing method according to the first embodiment;

FIG. 4 is a flowchart illustrating an example of an irradiation process of the additive manufacturing method according to the first embodiment;

FIGS. 5A-5D are a plan view of the rotating body when the irradiation processes in FIG. 3 and FIG. 4 are executed;

FIG. 6 is a flowchart illustrating an example of an irradiation process of the additive manufacturing method according to the first embodiment;

FIGS. 7A-7D are a schematic view of the rotating body when the irradiation processes in FIG. 3 and FIG. 6 are executed;

FIG. 8 is a schematic view illustrating an example of an additive manufacturing apparatus according to a second embodiment;

FIG. 9 is a block diagram illustrating an example of a controller of the additive manufacturing apparatus according to the second embodiment; and

FIG. 10 is a view taken in the direction of arrows X-X in FIG. 8.

### DETAILED DESCRIPTION

Hereinafter, embodiments of the present disclosure will be described with reference to the accompanying drawings. Note that in the following description, identical or corresponding elements are assigned the same reference numerals and duplicate description will not be repeated. Dimensional ratios among the drawings do not always coincide with the described ones. Twins “up,” “down,” “left” and “right” are based on the illustrated states, and are for convenience.

### First Embodiment

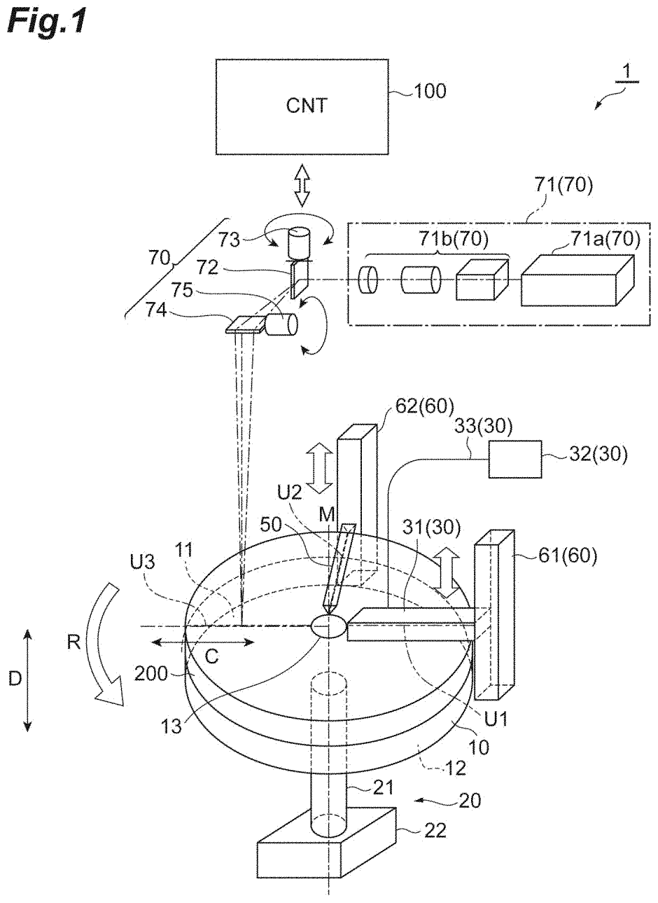

FIG. 1 is a schematic view illustrating an example of an additive manufacturing apparatus according to a first embodiment. The additive manufacturing apparatus 1 shown in FIG. 1 is an apparatus forming a molded object layer by layer. The additive manufacturing apparatus 1 is provided with a rotating body 10, a rotation drive unit 20, a supply unit 30, a flattening unit 50, a relative drive unit 60, an irradiation unit 70 and a controller 100. The additive manufacturing apparatus 1 forms a molded object layer by layer on a top surface 11 of the rotating body 10 rotated by the rotation drive unit 20. More specifically, the supply unit 30 supplies slurry to the top surface 11 of the rotating body 10 and forms a layer 200 of the slurry, the flattening unit 50 flattens the layer 200 of the slurry, and the irradiation unit 70 irradiates the layer 200 of the slurry with ultraviolet light and cures the layer 200 of the slurry to form a layer of the molded object. The relative drive unit 60 adjusts relative distances of the top surface 11 of the rotating body 10 from the supply unit 30 and the flattening unit 50. The slurry is a base material of the molded object. The slurry is, for example, a fluid material in which ultraviolet light curable resin and ceramic powder or metal powder are mixed. The slurry may be gel-like, semi-solid, jelly-like, mousse-like or paste-like resin. The ultraviolet light curable resin is resin that cures by receiving ultraviolet light, and is, for example, acrylic or epoxy-based.

The rotating body 10 shown in FIG. 1 is a cylindrical member. The rotating body 10 includes a circular top surface 11 and a circular undersurface 12. The rotating body 10 includes an axis of rotation M in a direction along a center line thereof. The center line of the rotating body 10 is a straight line connecting the centers of the circles of the top surface 11 and the undersurface 12 of the rotating body 10. Hereinafter, the direction along the center line of the rotating body 10 is assumed to be a center line direction D. The axis of rotation M extends, for example, in the center line direction D and is an axis connecting the centers of the circles of the top surface 11 and the undersurface 12 of the rotating body 10.

The top surface 11 is a circular horizontal surface on which a layer 200 of slurry is formed. The top surface 11 is orthogonal to the axis of rotation M. The top surface 11 includes, at a center thereof, a non-supply region 13 which is a circular region around the axis of rotation M to which no slurry is supplied. The supply unit 30, the flattening unit 50 and the irradiation unit 70 are provided so that they do not interfere with each other above the top surface 11. The supply unit 30, the flattening unit 50 and the irradiation unit 70 are provided above the top surface 11 except the non-supply region 13. The undersurface 12 is a circular surface parallel to the top surface 11.

The rotation drive unit 20 causes the rotating body 10 to rotate around the axis of rotation M. The rotation drive unit 20 is connected to the undersurface 12 of the rotating body 10. The rotation drive unit 20 includes a rod 21 and a drive source 22 causing the rod 21 to rotate. The rod 21 is provided, for example, in such a way as to coincide with the axis of rotation M along the center line direction D. A top end of the rod 21 is connected to the undersurface 12 of the rotating body 10 to support the rotating body 10. A bottom end of the rod 21 is connected to the drive source 22. The drive source 22 is, for example, a motor. The drive source 22 causes the rod 21 to rotate and thereby causes the rotating body 10 connected to the rod 21 to rotate around the axis of rotation M. A rotating direction R which is a direction in which the rotating body 10 is rotated by the rotation drive unit 20 is a direction in which an object placed on the top surface 11 of the rotating body 10 passes below the supply unit 30, below the flattening unit 50 and below the irradiation unit 70 in order. That is, in a plan view, the supply unit 30, the flattening unit 50 and the irradiation unit 70 are provided in order from upstream of the rotating body 10 in the rotating direction R.

The supply unit 30 supplies slurry containing ultraviolet light curable resin to the top surface 11 of the rotating body 10 during rotation of the rotating body 10 by the rotation drive unit 20 to form a slurry layer 200. The “supply unit 30 supplying slurry during rotation of the rotating body 10” means that supply of slurry by the supply unit 30 takes place simultaneously or alternately with rotation of the rotating body 10 by the rotation drive unit 20. The supply unit 30 includes, for example, a head 31 supplying slurry, a supply source 32 supplying slurry to the head 31, and a supply pipe 33 causing the head 31 to communicate with the supply source 32.

The head 31 is provided above the top surface 11 of the rotating body 10. The head 31 supplies slurry, for example, such that the top surface of the slurry layer 200 supplied to the top surface 11 of the rotating body 10 becomes a layer formation height position. The “layer formation height position” is a height prescribed as the height position of light radiated from the irradiation unit 70. The head 31 is separate from the top surface 11 of the rotating body 10, for example, such that its height corresponds to a height obtained by adding a thickness of the slurry layer 200 to the layer formation height position. The head 31 extends in the radial direction C from the axis of rotation M along the top surface 11 of the rotating body 10.

The head 31 supplies slurry to the top surface 11 of the rotating body 10 located directly below the head 31. For example, the head 31 linearly supplies slurry along the radial direction C from the outer circumference of the non-supply region 13 of the rotating body 10 to the outer circumference of the top surface 11 of the rotating body 10. When the top surface 11 of the rotating body 10 located directly below the head 31 is assumed to be a range U1, the head 31 supplies a predetermined amount of slurry in the range U1. Since the top surface 11 of the rotating body 10 passes below the head 31 as the rotating body 10 rotates, the head 31 can supply slurry to an arbitrary position of the top surface 11 of the rotating body 10. Slurry is supplied from the supply source 32 through the supply pipe 33 to the head 31. The amount of slurry supplied from the head 31 is determined based on the length of the range U1, the rotation speed of the rotating body 10 or the shape of the molded object or the like. The head 31 may include a vibration function to increase fluidity of slurry.

The flattening unit 50 flattens slurry supplied to the top surface 11 of the rotating body 10 to a thickness corresponding to one layer at an end portion thereof during rotation of the rotating body 10 by the rotation drive unit 20. The flattening unit 50 is, for example, a scraper. The “flattening unit 50 flattening slurry during rotation of the rotating body 10” means that slurry is flattened by the flattening unit 50 together with the rotation of the rotating body 10 by the rotation drive unit 20. The flattening unit 50 is located downstream of the supply unit 30 in the rotating direction R of the rotating body 10 above the top surface 11 of the rotating body 10. The flattening unit 50 extends in the radial direction C from the axis of rotation M along the top surface 11 of the rotating body 10. An end portion of the flattening unit 50 flattens slurry on the top surface 11 of the rotating body 10 located directly below the flattening unit 50. The flattening unit 50 linearly flattens slurry along the radial direction C from an outer circumference of the non-supply region 13 of the rotating body 10 to an outer circumference of the top surface 11 of the rotating body 10. When the top surface 11 of the rotating body 10 located directly below the flattening unit 50 is assumed to be a range U2, the flattening unit 50 flattens slurry on the top surface 11 of the rotating body 10 in the range U2. As the rotating body 10 rotates, the top surface 11 of the rotating body 10 passes below the flattening unit 50, and the flattening unit 50 can thereby flatten slurry at an arbitrary position of the top surface 11 of the rotating body 10. A one layer of the slurry layer 200 is formed on the top surface 11 of the rotating body 10 when the end portion of the flattening unit 50 flattens the slurry supplied from the supply unit 30 to the top surface 11 of the rotating body 10.

The relative drive unit 60 causes the rotating body 10 to relatively move with respect to the supply unit 30 and the flattening unit 50 toward the center line direction D. The relative drive unit 60 causes the supply unit 30 and the flattening unit 50 and the rotating body 10 to move along the center line direction D in such a way as to relatively come closer to or separate from each other. The relative drive unit 60 includes, for example, a first drive unit 61 and a second drive unit 62.

The first drive unit 61 causes the head 31 of the supply unit 30 to move in the center line direction D with respect to the top surface 11 of the rotating body 10. For example, the first drive unit 61 causes the head 31 to move in the center line direction D in units of one layer of thickness. The first drive unit 61 is constructed, for example, of a guide rail and a drive source. The first drive unit 61 is provided outside the outer circumference of the top surface 11 of the rotating body 10 in the radial direction C. The “outside” refers to the side opposite to the direction from the outer circumference of the top surface 11 of the rotating body 10 to the rotation axis M. The first drive unit 61 is connected to the end portion of the head 31 on the outer circumference side of the rotating body 10 and supports the head 31 such that the head 31 is located above the top surface 11 of the rotating body 10. The first drive unit 61 causes the head 31 to supply slurry to the top surface 11 of the rotating body 10 at a predetermined height to form the slurry layer 200.

The second drive unit 62 causes the flattening unit 50 to move in the center line direction D with respect to the top surface 11 of the rotating body 10. For example, the second drive unit 62 causes the flattening unit 50 to move in the center line direction D in units of one layer of thickness. The second drive unit 62 is constructed, for example, of a guide rail and a drive source. The second drive unit 62 is provided outside the outer circumference of the top surface 11 of the rotating body 10 in the radial direction C and is provided downstream of the first drive unit 61 in the rotating direction R of the rotating body 10. The second drive unit 62 is connected to an end portion of the flattening unit 50 on the outer circumference side of the rotating body 10 to support the flattening unit 50 such that the flattening unit 50 is located above the top surface 11 of the rotating body 10. The second drive unit 62 causes the flattening unit 50 to flatten the slurry layer 200 at a predetermined position with respect to the top surface 11 of the rotating body 10. The relative drive unit 60 may also drive the supply unit 30 and the flattening unit 50 using the first drive unit 61 and the second drive unit 62 as one common drive unit or may drive the supply unit 30 and the flattening unit 50 using them as two independent drive units respectively.

The irradiation unit 70 spot-radiates ultraviolet light at the irradiation position during rotation of the rotating body 10 by the rotation drive unit 20. The “irradiation position” refers to a position set in the slurry layer 200 and is a target position for irradiation with ultraviolet light. The “irradiation position” refers to a position defined based on the shape of the molded object and at which the slurry layer 200 is cured to form at least part of the molded object. The irradiation position is determined in such a way as to reproduce a cross-sectional shape based on, for example, CAD data of the molded object. The “spot-irradiation” here is an irradiation scheme under which ultraviolet light is condensed and an irradiation point (spot) is formed on slurry to obtain irradiation intensity necessary for ultraviolet light curable resin contained in the slurry to cure. The scale of the irradiation point by spot-irradiation is, for example, a circle having a diameter of 0.5 mm or more and 1 mm or less. The “irradiation unit 70 performing spot-irradiation with ultraviolet light during rotation of the rotating body 10” means that irradiation with ultraviolet light by the irradiation unit 70 is performed simultaneously or alternately with rotation of the rotating body 10 by the rotation drive unit 20.

The irradiation unit 70 is provided with, for example, an optical unit 71 and light reflecting members 72 and 74. The optical unit 71 is provided with, for example, a light source 71a and an optical member 71b, and emits ultraviolet light. The light reflecting members 72 and 74 are, for example, Galvano-mirrors and change an optical path of ultraviolet light emitted from the optical unit 71. The light reflecting members 72 and 74 are caused by rotation small drive units 73 and 75 to perform rotation operation around a predetermined axis of rotation. With rotations of the light reflecting members 72 and 74 being controlled, the irradiation unit 70 can irradiate slurry with ultraviolet light at the irradiation position and at a layer formation height position.

The irradiation unit 70 irradiates, for example, the top surface 11 of the rotating body 10 located directly below the irradiation unit 70 with ultraviolet light. The irradiation unit 70, for example, performs spot-irradiation with ultraviolet light in such a way as to scan, for example, a line segment along the radial direction C from an outer circumference of the non-supply region 13 of the rotating body 10 to an outer circumference of the top surface 11 of the rotating body 10. When the top surface 11 of the rotating body 10 located directly below the irradiation unit 70 is assumed to be a range U3, the irradiation unit 70 controls the light reflecting members 72 and 74, and the rotation small drive units 73 and 75 so that slurry on the top surface 11 of the rotating body 10 in the range U3 can be irradiated with ultraviolet light.

Of the irradiation unit 70, at least the light reflecting member 74 and the rotation small drive unit 75 are provided above the top surface 11 of the rotating body 10 and located downstream of the flattening unit 50 in the rotating direction R of the rotating body 10. The ultraviolet light curable resin contained in slurry is cured by the irradiation unit 70 irradiating the slurry layer 200 flattened by the flattening unit 50 with ultraviolet light at the irradiation position. The irradiation unit 70 forms a cross section corresponding to one layer of the molded object by irradiating the slurry with ultraviolet light at the irradiation position of the layer 200 of slurry during rotation of the rotating body 10.

The controller 100 is hardware controlling the additive manufacturing apparatus 1. The controller 100 is constructed of a general-purpose computer including, for example, an operation apparatus such as a CPU (Central Processing Unit), a storage apparatus such as ROM (Read Only Memory), RAM (Random Access Memory), HDD (Hard Disk Drive) and a communication apparatus. The controller 100 is communicably connected to the rotation drive unit 20, the supply unit 30, the relative drive unit 60 and the irradiation unit 70.

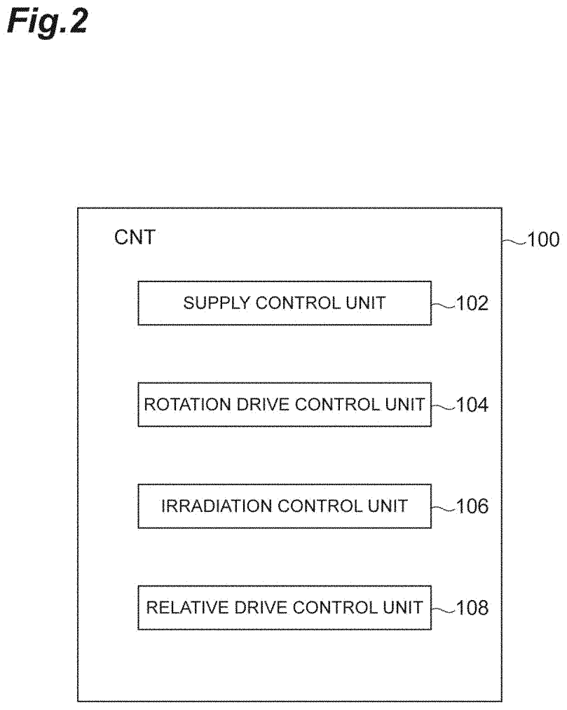

FIG. 2 is a block diagram illustrating an example of a control unit of the additive manufacturing apparatus according to the first embodiment. As shown in FIG. 2, the controller 100 includes a supply control unit 102, a rotation drive control unit 104, an irradiation control unit 106 and a relative drive control unit 108. The supply control unit 102 controls the amount and the supply speed of slurry supplied to the top surface 11 of the rotating body 10 by the supply unit 30 or the like.

The rotation drive control unit 104 controls the rotating direction R, the rotation speed, the number of revolutions, the angle of rotation, rotation start and rotation stop of the rotating body 10 in the rotation drive unit 20. The angle of rotation is an angle indicating the position of the rotating body 10 on the top surface 11 at which a supply of slurry corresponding to one layer starts and is expressed using a reference position of rotation. The “reference position of rotation” is a predetermined fixed position which becomes an origin of the rotation angle, and can be, for example, a position directly below the irradiation unit 70, that is, the position of the range U3. The rotation drive unit 20 monitors a position of the rotating body 10 on the top surface 11 at which a supply of slurry corresponding to one layer starts as a measurement position using the position of the range U3 as a reference. That is, the rotation drive unit 20 expresses the position of the rotating body 10 on the top surface 11 at which a supply of slurry corresponding to one layer starts with an angle of rotation using the position of the range U3 as an origin position. When the reference position coincides with the measurement position, the rotation drive control unit 104 regards the angle of rotation as 0 degrees (origin) and increases the angle of rotation every time the measurement position moves in the rotating direction R. When the reference position coincides with the measurement position again, the rotation drive control unit 104 regards the angle of rotation as 0 degrees. The rotation drive control unit 104 determines whether or not the rotating body 10 has made one rotation based on the angle of rotation of the measurement position and measures the number of revolutions.

The irradiation control unit 106 controls the intensity of ultraviolet light or the position of the irradiation point of ultraviolet light radiated from the irradiation unit 70. The “position of the irradiation point” refers to a position at which the irradiation unit 70 radiates ultraviolet light. More specifically, the position of the irradiation point is a position at which the ultraviolet light radiated from the irradiation unit 70 reaches the slurry on the top surface 11 of the rotating body 10.

The relative drive control unit 108 controls the relative drive unit 60. The relative drive control unit 108 controls relative distances of the supply unit 30 and the flattening unit 50 from the rotating body 10, a speed and timing at which the supply unit 30 and the flattening unit 50 are caused to relatively come closer to or separate from the rotating body 10.

The controller 100 causes the rotation drive unit 20, the supply unit 30, the relative drive unit 60 and the irradiation unit 70 to operate based on three-dimensional CAD data of the molded object stored in the storage apparatus. The controller 100 may be provided outside the additive manufacturing apparatus 1.

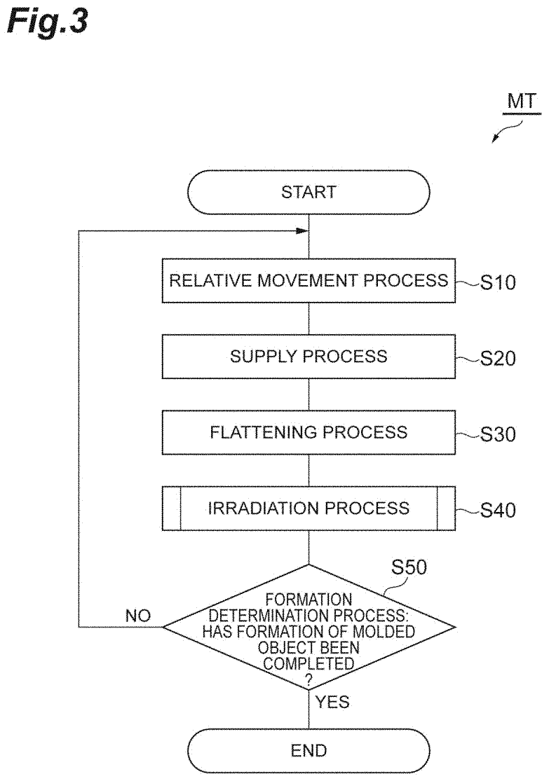

Next, steps of manufacturing a molded object by the additive manufacturing apparatus 1 will be described. FIG. 3 is a flowchart illustrating an example of the additive manufacturing method according to the first embodiment. An additive manufacturing method MT shown in FIG. 3 is executed by the controller 100 during rotation of the rotating body 10 by the rotation drive unit 20.

First, in a relative movement process (S10), the relative drive control unit 108 of the controller 100 causes the relative drive unit 60 to adjust distances of the head 31 and the flattening unit 50 from the top surface 11 of the rotating body 10 so that the top surface of the slurry supplied from the head 31 of the supply unit 30 becomes the layer formation height position. Based on the control of the relative drive control unit 108, the first drive unit 61 causes the head 31 to move in the center line direction D to adjust the distance from the top surface 11 of the rotating body 10 in the center line direction D. The head 31 is adjusted in such a way as to be located at a height obtained by adding a height corresponding to one layer of the slurry layer 200 to the layer formation height position.

Based on the control of the relative drive control unit 108, the second drive unit 62 causes the flattening unit 50 to move in the center line direction D to adjust the distance from the top surface 11 of the rotating body 10 in the center line direction D. The flattening unit 50 is adjusted so that the end portion thereof is located at the layer formation height position. In the relative movement process (S10), the rotation of the rotating body 10 by the rotation drive unit 20 may be stopped.

Next, the supply control unit 102 of the controller 100 causes the supply unit 30 to supply slurry to the top surface 11 of the rotating body 10 as a supply process (S20). The supply control unit 102 causes the supply source 32 to supply slurry to the head 31 via the supply pipe 33. The head 31 supplies slurry to the top surface 11 (range U1) of the rotating body 10 directly below the head 31. This causes slurry to be given to the top surface 11 of the rotating body 10 that has passed directly below the head 31.

Next, the controller 100 causes the flattening unit 50 to flatten the slurry supplied to the top surface 11 of the rotating body 10 to a thickness corresponding to one layer during rotation of the rotating body 10 by the rotation drive unit 20 as a flattening process (S30). The slurry supplied by the supply unit 30 moves to a position below the flattening unit 50 located downstream of the rotating body 10 in the rotating direction R. The flattening unit 50 flattens slurry on the top surface 11 (range U2) of the rotating body 10 directly below the flattening unit 50. In this way, one layer of the slurry layer 200 is formed on the top surface 11 of the rotating body 10 that has passed directly below the flattening unit 50.

Next, the irradiation control unit 106 of the controller 100 causes the irradiation unit 70 to spot-irradiate the flattened slurry layer 200 with ultraviolet light at the irradiation position on the top surface 11 of the rotating body 10 during rotation of the rotating body 10 by the rotation drive unit 20 as an irradiation process (S40). The slurry layer 200 flattened by the flattening unit 50 moves to a position below the irradiation unit 70 located downstream of the rotating body 10 in the rotating direction R. The irradiation unit 70 spot-irradiates the slurry layer 200 with ultraviolet light at the irradiation position on the top surface 11 (range U3) of the rotating body 10 directly below the light reflecting member 74. As the rotating body 10 rotates, the irradiation unit 70 spot-irradiates the slurry layer 200 with ultraviolet light at all the irradiation positions and forms a cross section corresponding to one layer of the molded object as a layer of the molded object on the top surface 11 of the rotating body 10.

Next, the controller 100 determines whether or not formation of the molded object on the top surface 11 of the rotating body 10 has been completed as a formation determination process (S50). Based on, for example, three-dimensional CAD data of the molded object stored in the storage apparatus, the number of revolutions of the rotating body 10, the height position of the head 31 of the supply unit 30 and the position of the irradiation point of the irradiation unit 70 or the like, when irradiations with ultraviolet light at all the irradiation positions have been completed, the controller 100 determines that the formation of the molded object has been completed. When the controller 100 determines that the formation of the molded object has been completed, the controller 100 ends the formation of the molded object by the additive manufacturing apparatus 1. When the controller 100 determines that the formation of the molded object has not been completed, the controller 100 proceeds to the relative movement process (S10). The controller 100 repeats the relative movement process (S10) and subsequent processes until the formation of the molded object is completed.

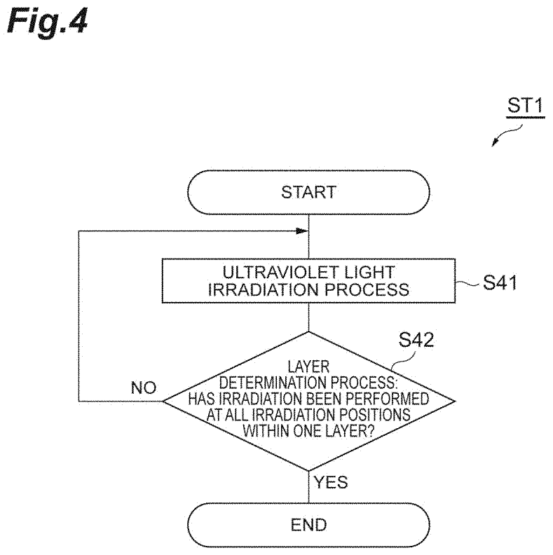

Next, a specific example of an irradiation process (S40) by the additive manufacturing apparatus 1 will be described. FIG. 4 is a flowchart illustrating an example of the irradiation process of the additive manufacturing method according to the first embodiment. An additive manufacturing method example ST1 shown in FIG. 4 is executed by the controller 100 when the irradiation position in the slurry layer 200 flattened in the flattening process (S30) shown in FIG. 3 during rotation of the rotating body 10 by the rotation drive unit 20 rotates and moves to the range U3. In the additive manufacturing method example ST1, the irradiation unit 70 spot-irradiates the one layer of the slurry layer 200 with ultraviolet light at all the irradiation positions during one rotation of the rotating body 10. Note that in the additive manufacturing method example ST1, the supply process (S20) by the supply unit 30 and the flattening process (S30) by the flattening unit 50 shown in FIG. 3 may be executed simultaneously.

First, in an ultraviolet light irradiation process (S41), the irradiation control unit 106 of the controller 100 causes the irradiation unit 70 to spot-irradiate the slurry layer 200 flattened on the top surface 11 of the rotating body 10 with ultraviolet light at the irradiation position. The irradiation unit 70 spot-irradiates the top surface 11 (range U3) of the rotating body 10 directly below the light reflecting member 74 at all the irradiation positions through adjustments by the light reflecting members 72 and 74, and the rotation small drive units 73 and 75.

Next, the controller 100 determines whether or not the irradiation unit 70 has irradiated the one layer of the slurry layer 200 with ultraviolet light at all the irradiation positions as a layer determination process (S42). More specifically, the controller 100 determines whether or not the slurry layer 200 has been irradiated with ultraviolet light at all the irradiation positions based on the irradiation position and the angle of rotation on the slurry layer 200.

Alternatively, the controller 100 may determine whether or not the angle of rotation measured by the rotation drive control unit 104 has become 0 degrees. When the controller 100 determines that the irradiation unit 70 has irradiated the one layer of the slurry layer 200 with ultraviolet light at all the irradiation positions, since the one layer of the slurry layer 200 has been spot-irradiated with ultraviolet light at all the irradiation positions during one rotation of the rotating body 10, the irradiation process (S40) by the additive manufacturing apparatus 1 is ended.

When the controller 100 determines that the irradiation unit 70 has not irradiated the one layer of the slurry layer 200 with ultraviolet light at all the irradiation positions, the controller 100 causes the rotation drive control unit 104 to rotate the rotating body 10 until the irradiation position upstream in the rotating direction R moves into the range U3, and then the controller 100 proceeds to the ultraviolet light irradiation process (S41). The controller 100 repeats the ultraviolet light irradiation process (S41) and subsequent processes until it is determined that the irradiation unit 70 has irradiated the one layer of the slurry layer 200 with ultraviolet light at all the irradiation positions.

When the measurement position passes through the range U1 while the additive manufacturing method example ST1 is being executed, the supply control unit 102 of the controller 100 causes the supply unit 30 to supply slurry to the slurry layer 200 as the supply process in FIG. 3 (S20). When the measurement position passes through the range U2 while the additive manufacturing method example ST1 is being executed, the controller 100 causes the flattening unit 50 to flatten the slurry supplied to the slurry layer 200 as the flattening process (S30).

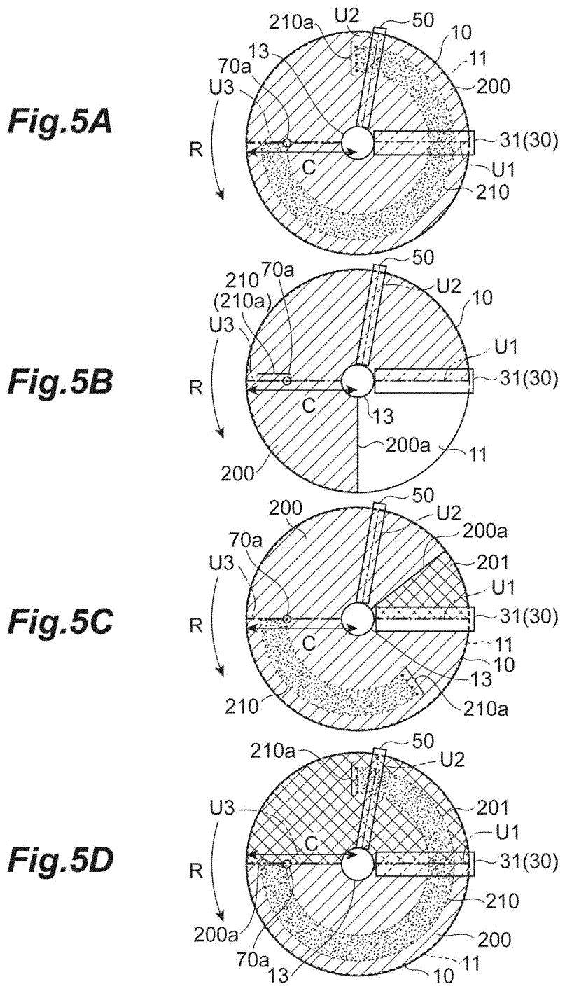

FIGS. 5A-5D are a plan view of the rotating body when the irradiation processes in FIG. 3 and FIG. 4 are executed. FIG. 5A illustrates all irradiation positions 210 by the irradiation unit 70 on the one layer of the slurry layer 200. As shown in FIG. 5A, ultraviolet light radiated from the irradiation unit 70 is represented by points (spots) such as an irradiation point 70a with the slurry on the top surface 11 of the rotating body 10. In the additive manufacturing method example ST1, the position of the irradiation point 70a moves in the radial direction C every time the rotating body 10 moves in the rotating direction R. Among the irradiation positions 210, a most downstream part in the rotating direction R is assumed to be a most downstream irradiation position 210a. Hereinafter, an example in which the position of the irradiation point 70a is aligned with the irradiation position 210 shown in FIG. 5A will be described using FIGS. 5B to 5D.

FIG. 5B illustrates a state in which the first ultraviolet light irradiation process (S41) has been completed by the irradiation unit 70 on the one layer of the slurry layer 200. As shown in FIG. 5B, in the slurry layer 200 supplied by the head 31 of the supply unit 30 and flattened by the flattening unit 50, a measurement position 200a is located downstream of the range U3 in the rotating direction R. When the irradiation position 210 is not set in the part which is about to pass through the irradiation unit 70, the slurry layer 200 passes through the range U3 without being irradiated with ultraviolet light by the irradiation unit 70. The irradiation unit 70 in the additive manufacturing method example ST1 irradiates the slurry layer 200 in the range U3 with ultraviolet light at all the irradiation positions 210 during one rotation of the rotating body 10 by the rotation drive unit 20. By moving the position of the irradiation point 70a in the radial direction C in the range U3, the irradiation unit 70 can radiate ultraviolet light at all the irradiation positions 210 in the range U3. In this way, one layer of the molded object is formed in the radial direction C of the one layer of the slurry layer 200.

FIG. 5C illustrates a state in which the irradiation unit 70 has completed the ultraviolet light irradiation process (S41) a plurality of times on the one layer of the slurry layer 200. As shown in FIG. 5C, in the additive manufacturing method example ST1, the most downstream irradiation position 210a is located downstream of the range U3 in the rotating direction R because it rotates even after the ultraviolet light irradiation process (S41).

In the additive manufacturing method example ST1, a layer of the molded object corresponding to one layer is formed during one rotation, and so the supply unit 30 can supply an upper layer 201 of slurry to the layer of the molded object through the relative movement process (S10) and the supply process (S20). For this reason, after the measurement position 200a passes through the range U1 below the head 31, slurry is supplied from the head 31 to the top surface of the slurry layer 200. In this way, the upper layer 201 of slurry is supplied to the top surface of the slurry layer 200 from the range U1 to the measurement position 200a downstream in the rotating direction R. Thus, according to the additive manufacturing method example ST1, since the slurry layer 200 can be formed continuously, it is possible to improve the manufacturing speed of the molded object.

FIG. 5D illustrates a state in which the irradiation unit 70 has completed all the ultraviolet light irradiation processes (S41) on the one layer of the slurry layer 200. As shown in FIG. 5D, the most downstream irradiation position 210a reaches a position passing through the range U1 downstream of the range U3 in the rotating direction R. For a time period until the measurement position 200a reaches the range U3 (reference position), the whole one layer of the molded object is formed. Along with the ultraviolet light irradiation process (S41) when the measurement position 200a reaches the range U3 (reference position) and subsequent processes, a layer of the molded object is also formed at the irradiation position 210 of the upper layer 201 of slurry.

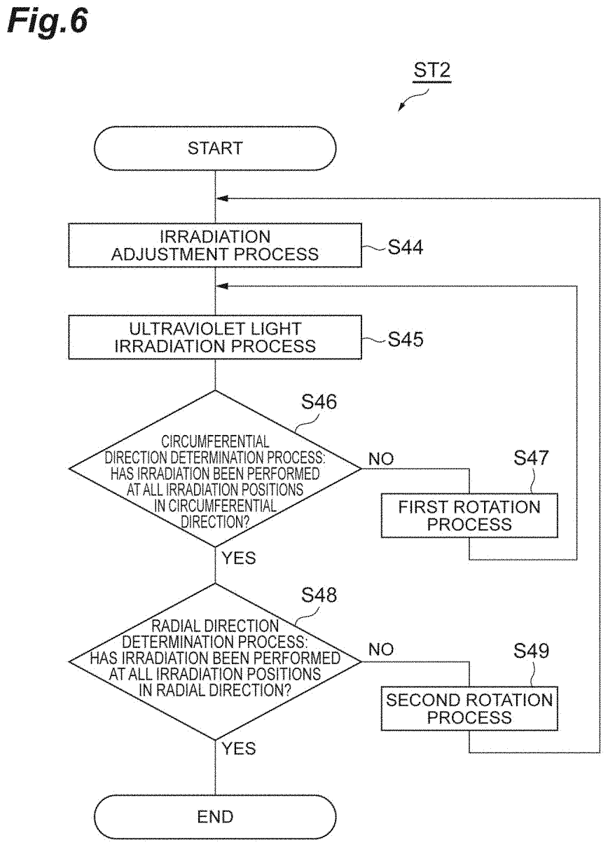

Next, another specific example of the irradiation process (S40) by the additive manufacturing apparatus 1 will be described. FIG. 6 is a flowchart illustrating an example of the irradiation process of the additive manufacturing method according to the first embodiment. An additive manufacturing method example ST2 shown in FIG. 6 is executed by the controller 100 when the irradiation position 210 of the slurry layer 200 flattened in the flattening process (S30) shown in FIG. 3 rotates and moves to the range U3. After the irradiation position 210 rotates and moves to the range U3, the controller 100 stops the rotation of the rotating body 10 by the rotation drive unit 20, and then proceeds to each process in the additive manufacturing method example ST2.

In the additive manufacturing method example ST2, the irradiation unit 70 changes the position of the irradiation point 70a of ultraviolet light along the radial direction C of the rotating body 10 for every rotation of the rotating body 10. The irradiation unit 70 performs control in such a way as to prevent the position of the irradiation point 70a from moving in the radial direction C during one rotation of the rotating body 10. This allows the irradiation unit 70 to scan the position of the irradiation point 70a in such a way as to describe a circle around the central axis of the rotating body 10 on the top surface of the rotating body 10 as the rotating body 10 rotates. Thus, the irradiation unit 70 can realize line irradiation in the rotating direction R of the rotating body 10 using spot-irradiation and rotation of the rotating body 10. When a plurality of irradiation positions 210 are set along the radial direction C at positions of the range U3 of the one layer of the slurry layer 200, every time the rotation drive unit 20 causes the rotating body 10 to make one rotation, the irradiation unit 70 moves the position of the irradiation point 70a in the radial direction C and spot-irradiates the one layer of the slurry layer 200 with ultraviolet light at the irradiation position 210. Note that the additive manufacturing method example ST2 is different from the additive manufacturing method example ST1 in that the supply process (S20) by the supply unit 30 shown in FIG. 3 and the flattening process (S30) by the flattening unit 50 are not executed simultaneously.

First, in an irradiation adjustment process (S44), the irradiation control unit 106 of the controller 100 causes the irradiation unit 70 to recognize the irradiation position 210 in the one layer of the slurry layer 200 based on three-dimensional CAD data of the molded object stored in the storage apparatus. The irradiation unit 70 fixes the position of the irradiation point 70a in the radial direction C based on the irradiation position 210 on the one layer of the slurry layer 200.

Next, the irradiation control unit 106 of the controller 100 causes the irradiation unit 70 to spot-irradiate slurry flattened on the top surface 11 of the rotating body 10 with ultraviolet light at the irradiation position 210 as a ultraviolet light irradiation process (S45). The irradiation unit 70 performs spot-irradiation at the irradiation position 210 coinciding with the fixed position of the irradiation point 70a within the range U3. That is, in the additive manufacturing method example ST2, even when there are other irradiation positions 210 at positions other than the irradiation point 70a in the radial direction C of the range U3, the irradiation unit 70 does not perform spot-irradiation with ultraviolet light at the irradiation position 210.

Next, the controller 100 determines whether or not the irradiation unit 70 has irradiated the one layer of the slurry layer 200 with ultraviolet light at all the irradiation positions 210 in the rotating direction R at the fixed position of the irradiation point 70a of the irradiation position 210 as a circumferential direction determination process (S46). In the ultraviolet light irradiation process (S45), the controller 100 determines whether or not there is any irradiation position 210 at which the one layer of the slurry layer 200 in the upstream direction of the rotating direction R from the irradiation position 210 at which ultraviolet light is radiated from the irradiation unit 70, not irradiated with ultraviolet light by the irradiation unit 70.

In the circumferential direction determination process (S46), when it is determined that the irradiation unit 70 has not irradiated the one layer of the slurry layer 200 with ultraviolet light at all the irradiation positions 210 in the rotating direction R at the fixed position of the irradiation point 70a of the irradiation position 210, the controller 100 proceeds to a first rotation process (S47). The controller 100 causes the rotation drive unit 20 to rotate the rotating body 10 as the first rotation process (S47). The rotation drive control unit 104 causes the rotating body 10 to rotate until the irradiation position 210 downstream in the rotating direction R moves to the fixed position of the irradiation point 70a in the range U3. When the first rotation process (S47) ends, the controller 100 proceeds to the ultraviolet light irradiation process (S45). The controller 100 repeats the ultraviolet light irradiation process (S45) and subsequent processes until the irradiation unit 70 irradiates the one layer of the slurry layer 200 with ultraviolet light at all the irradiation positions 210 in the rotating direction R at the fixed position of the irradiation point 70a of the irradiation position 210.

In the circumferential direction determination process (S46), when it is determined that the irradiation unit 70 has radiated ultraviolet light at all the irradiation positions 210 in the rotating direction R, the controller 100 proceeds to a radial direction determination process (S48). As the radial direction determination process (S48), the controller 100 determines whether or not the irradiation unit 70 has irradiated the one layer of the slurry layer 200 in the radial direction C with ultraviolet light at all the irradiation positions 210. The controller 100 determines, in the ultraviolet light irradiation process (S45), whether or not the irradiation unit 70 has irradiated the one layer of the slurry layer 200 with ultraviolet light at all the irradiation positions 210 based on three-dimensional CAD data of the molded object stored in the storage apparatus.

When it is determined, in the radial direction determination process (S48), that the irradiation unit 70 has not irradiated the one layer of the slurry layer 200 with ultraviolet light at all the irradiation positions 210, the controller 100 proceeds to a second rotation process (S49). As the second rotation process (S49), the controller 100 causes the rotation drive unit 20 to rotate the rotating body 10. The rotation drive control unit 104 rotates the rotating body 10 until the irradiation position 210 located upstream in the rotating direction R moves into the range U3. When the second rotation process (S49) ends, the controller 100 proceeds to the irradiation adjustment process (S44). The controller 100 moves the position of the irradiation point 70a in the radial direction C and fixes the position. The controller 100 repeats the irradiation adjustment process (S44) and subsequent processes until the irradiation unit 70 irradiates the slurry layer 200 with ultraviolet light at all the irradiation positions 210.

When it is determined, in the radial direction determination process (S48), that the irradiation unit 70 has irradiated the one layer of the slurry layer 200 with ultraviolet light at all the irradiation positions 210, the controller 100 ends the irradiation process (S40).

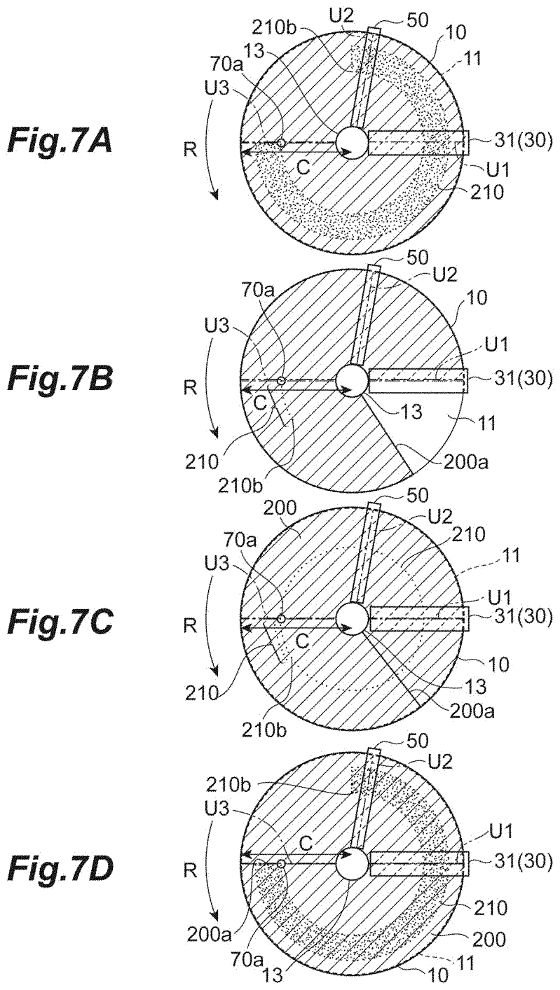

FIGS. 7A-7D are a plan view of the rotating body when the irradiation processes in FIG. 3 and FIG. 6 are executed. FIG. 7A illustrates all the irradiation positions 210 on the one layer of the slurry layer 200 by the irradiation unit 70. As shown in FIG. 7A, ultraviolet light radiated from the irradiation unit 70 is represented by points (spots) such as the irradiation point 70a on the top surface 11 of the rotating body 10. The position of the irradiation point 70a moves in the radial direction C through the irradiation adjustment process (S44) executed by the controller 100. Among the irradiation positions 210, a position at which the irradiation control unit 106 initially aligns the irradiation position 210 with the position of the irradiation point 70a is assumed to be an initial irradiation position 210b. Hereinafter, an example where the position of the irradiation point 70a is aligned with the irradiation position 210 shown in FIG. 7A will be described using FIGS. 7B to 7D.

FIG. 7B illustrates a state in which the irradiation unit 70 has executed the circumferential direction determination process (S46) a plurality of times on the one layer of the slurry layer 200 and has executed the ultraviolet light irradiation process (S45) a plurality of times via the first rotation process (S47). As shown in FIG. 7B, the slurry layer 200 supplied by the head 31 of the supply unit 30, flattened by the flattening unit 50 and reaching the range U3 is spot-irradiated with ultraviolet light at the irradiation position 210 that is aligned with the fixed position of the irradiation point 70a among the irradiation positions 210 of the one layer of the slurry layer 200. The irradiation unit 70 in the additive manufacturing method example ST2 irradiates the slurry layer 200 within the range U3 with ultraviolet light at the irradiation position 210 that is aligned with the fixed position of the irradiation point 70a in the radial direction C. As shown in FIG. 7B, since the initial irradiation position 210B in the additive manufacturing method example ST2 rotates even after the ultraviolet light irradiation process (S41), the initial irradiation position 210B is located downstream of the range U3 in the rotating direction R.

FIG. 7C illustrates a state in which the irradiation unit 70 further executes the ultraviolet light irradiation process (S45) a plurality of times on the one layer of the slurry layer 200 after FIG. 7B, executes the radial direction determination process (S48) once, executes the irradiation adjustment process (S44) for the second time via the second rotation process (S49) and executes the circumferential direction determination process (S46) a plurality of times. As shown in FIG. 7C, in the additive manufacturing method example ST2, during one rotation of the rotating body 10 by the rotation drive unit 20, since the irradiation control unit 106 fixes the position of the irradiation point 70a in the radial direction C, the irradiation unit 70 is in a state in which it has radiated ultraviolet light at all the irradiation positions 210 in the rotating direction R at a certain position in the radial direction C. Thus, according to the additive manufacturing method example ST2, since the irradiation unit 70 need not change the position of the irradiation point 70a in the radial direction C in accordance with the angle at which the rotation drive unit 20 rotates the rotating body 10, it is possible to improve the manufacturing speed of the molded object.

By the time the irradiation unit 70 has radiated ultraviolet light at all the irradiation positions 210, the relative drive control unit 108 adjusts, through the relative drive unit 60, relative distances of the supply unit 30 and the flattening unit 50 from the top surface 11 of the rotating body 10. In this way, layers of molded objects on upper layers of the slurry layer 200 can also be formed continuously after forming layers of the molded objects on the slurry layer 200, and so the additive manufacturing method example ST2 can improve the manufacturing speed of the molded object.

FIG. 7D illustrates a state in which the irradiation unit 70 has completed all the ultraviolet light irradiation processes (S45) on the one layer of the slurry layer 200. As shown in FIG. 7D, the supply unit 30 does not supply the upper layer of slurry to the top surface of the slurry layer 200 until the slurry layer 200 is irradiated with ultraviolet light at all the irradiation positions 210. When the slurry layer 200 has been irradiated with ultraviolet light at all the irradiation positions 210, the supply unit 30 may start forming the upper layer of slurry even when the measurement position 200a of the slurry layer 200 has not reached the range U1 below the head 31.

As described so far, the additive manufacturing apparatus 1 and the additive manufacturing method MT according to the present embodiment can improve the manufacturing speed of a molded object. Furthermore, since the rotation drive unit 20 causes the top surface 11 of the rotating body 10 to move in the rotating direction R with respect to the supply unit 30, the flattening unit 50 and the irradiation unit 70, the supply unit 30, the flattening unit 50 and the irradiation unit 70 need not move in the rotating direction R. For this reason, the supply unit 30, the flattening unit 50 and the irradiation unit 70 can execute processes without waiting for the movement of each component to be completed, and can thereby form layers of the molded object continuously.

Furthermore, the rotating body 10 can relatively move with respect to the supply unit 30 and the flattening unit 50 through the relative drive unit 60 without waiting for a process of each component to be completed. It is thereby possible to shorten the time to wait for each component to complete movement or processing.

According to the additive manufacturing method example ST1, formation of one layer of the molded object is completed while the rotation drive unit 20 causes the rotating body 10 to make one rotation from the irradiation position 210 of irradiation with ultraviolet light by the irradiation unit 70. Thus, the additive manufacturing method example ST1 can execute the respective processes by the supply unit 30, the flattening unit 50 and the irradiation unit 70 continuously. Since the head 31 is separate from the top surface 11 of the rotating body 10 in such a way as to, for example, have a height obtained by adding the height of the slurry layer 200 to the layer formation height position, the relative drive unit 60 may adjust a relative distance between the supply unit 30 and the rotating body 10 while forming the upper layer 201 of slurry. In this way, the supply unit 30 can form the upper layer 201 of slurry continuously after the slurry layer 200.

According to the additive manufacturing method example ST2, the irradiation unit 70 need not change the position of the irradiation point 70a of the rotating body 10 in the radial direction C while the rotating body 10 makes one rotation after starting irradiation with ultraviolet light. Thus, in the additive manufacturing method example ST2, it is possible to reduce time required to change the position of the irradiation point 70a by the irradiation unit 70. While the irradiation unit 70 changes the position of the irradiation point 70a in the radial direction C for every rotation of the rotating body 10 and radiates ultraviolet light, the relative drive unit 60 can adjust the relative distances of the supply unit 30 and the flattening unit 50 from the top surface 11 of the rotating body 10. When the slurry layer 200 is irradiated with ultraviolet light at all the irradiation positions 210, the supply unit 30 can start forming the upper layer of slurry even when the measurement position 200a of the slurry layer 200 has not reached the range U1 below the head 31.

### Second Embodiment

Next, an additive manufacturing apparatus according to a second embodiment will be described. In the present embodiment, differences from the first embodiment will be described and duplicate description will be omitted. The additive manufacturing apparatus according to the second embodiment is different from the additive manufacturing apparatus 1 according to the first embodiment in that a slurry layer is supplied, flattened and irradiated with ultraviolet light on an outer circumferential surface of the rotating body.

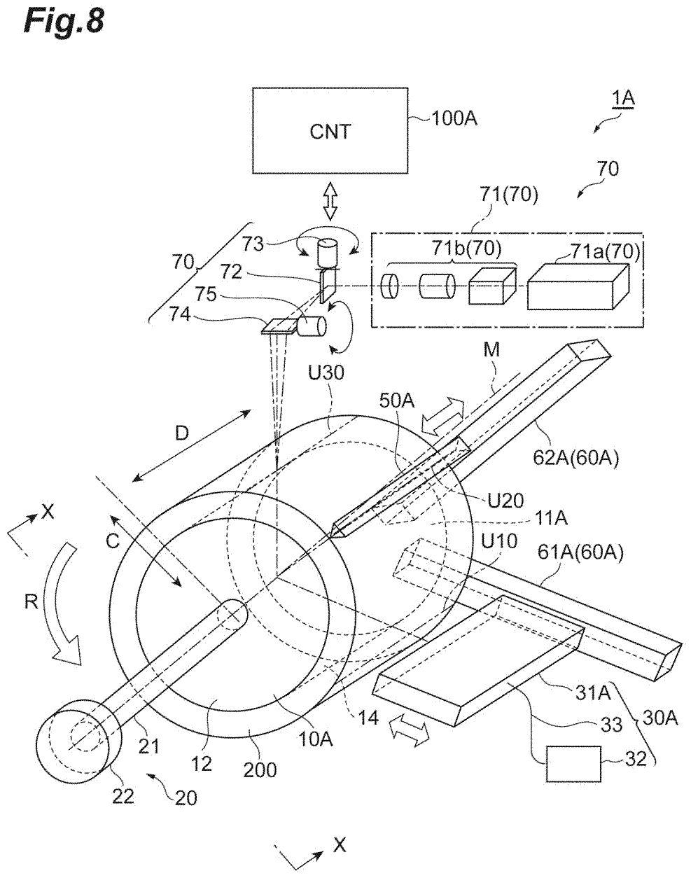

FIG. 8 is a schematic view illustrating an example of an additive manufacturing apparatus according to the second embodiment. An additive manufacturing apparatus 1A shown in FIG. 8 is provided with a rotating body 10A, a rotation drive unit 20A, a supply unit 30A, a flattening unit 50A, a first drive unit 61A, a second drive unit 62A, an irradiation unit 70 and a controller 100A. Hereinafter, a configuration including the first drive unit 61A and the second drive unit 62A is expressed as a “relative drive unit 60A.” The additive manufacturing apparatus 1A forms a molded object layer by layer on an outer circumferential surface 14 of the rotating body 10A rotated by the rotation drive unit 20A. More specifically, the supply unit 30A supplies slurry to the outer circumferential surface 14 of the rotating body 10A to form a slurry layer 200, the flattening unit 50A flattens the slurry layer 200, the irradiation unit 70 irradiates the slurry layer 200 with ultraviolet light to cure the slurry layer 200, and a layer of a molded object is thereby formed. The relative drive unit 60A adjusts relative distances of the outer circumferential surface 14 of the rotating body 10A from the supply unit 30A and the flattening unit 50A.

The rotating body 10A is a cylindrical member. The rotating body 10A includes a circular top surface 11A, a circular undersurface 12 and an outer circumferential surface 14 connecting the top surface 11A and the undersurface 12. The rotating body 10A has an axis of rotation M in a direction along a center line thereof. The center line of the rotating body 10A is a straight line connecting the centers of the circles of the top surface 11A and the undersurface 12 of the rotating body 10A. Hereinafter, the direction along the center line of the rotating body 10A is assumed to be a center line direction D. The axis of rotation M is, for example, an axis extending, for example, in the center line direction D and connecting the centers of the circles of the top surface 11A and the undersurface 12 of the rotating body 10A. The outer circumferential surface 14 is a circumferential surface of the cylinder on the surface of which the slurry layer 200 is formed. The outer circumferential surface 14 is provided along the axis of rotation M. The supply unit 30A, the flattening unit 50A and the irradiation unit 70 are disposed at positions separate from the outer circumferential surface 14 in the radial direction C from the axis of rotation M.

The rotation drive unit 20A causes the rotating body 10A to rotate around the axis of rotation M. The rotation drive unit 20A is connected to, for example, the undersurface 12 of the rotating body 10A. The rotating direction R of the rotating body 10A by the rotation drive unit 20A is a direction in which an object placed on the outer circumferential surface 14 of the rotating body 10A passes below the supply unit 30A, below the flattening unit 50A and below the irradiation unit 70 in order. That is, the supply unit 30A, the flattening unit 50A and the irradiation unit 70 are provided in order from upstream of the rotating body 10A in the rotating direction R.

The supply unit 30A supplies slurry to the outer circumferential surface 14 of the rotating body 10A during rotation of the rotating body 10A by the rotation drive unit 20A to form a slurry layer 200. The supply unit 30A includes, for example, a head 31A supplying slurry, a supply source 32 supplying slurry to the head 31A and a supply pipe 33 allowing the head 31A and the supply source 32 to communicate with each other.

The head 31A of the supply unit 30A is provided outward in the radial direction C of the outer circumferential surface 14 of the rotating body 10A. Here, a direction from the outer circumferential surface 14 of the rotating body 10A toward the axis of rotation M along the radial direction C is an inward direction, and a direction opposite to that direction is an outward direction. The head 31A supplies slurry so that the surface in the outward direction of the slurry layer 200 supplied, for example, onto the outer circumferential surface 14 of the rotating body 10A is located at a layer formation height position. The head 31A is separate from the outer circumferential surface 14 of the rotating body 10A outward in the radial direction C in such a way as to be located, for example, at the layer formation height position. The head 31A extends in the center line direction D along the outer circumferential surface 14 of the rotating body 10A. The head 31A has a length, for example, from the top surface 11A to the undersurface 12 in the center line direction D.

The head 31A supplies slurry to the outer circumferential surface 14 of the rotating body 10A located inward in the radial direction C of the head 31A. For example, the head 31A supplies slurry linearly along the center line direction D from the outer circumference of the top surface 11A of the rotating body 10A to the outer circumference of the undersurface 12. When the outer circumferential surface 14 of the rotating body 10A located inward in the radial direction C of the head 31A is assumed to be a range U10, the head 31A supplies a predetermined amount of slurry to the range U10. The outer circumferential surface 14 of the rotating body 10A passes below the head 31A as the rotating body 10A rotates, and so the head 31A can supply slurry at an arbitrary position of the outer circumferential surface 14 of the rotating body 10A. The amount of slurry supplied from the head 31A is determined based on the length of the range U10, the rotation speed of the rotating body 10A or the shape of the molded object or the like.

The flattening unit 50A flattens the slurry supplied to the outer circumferential surface 14 of the rotating body 10A at an end portion thereof to a thickness corresponding to one layer during rotation of the rotating body 10A by the rotation drive unit 20A. The flattening unit 50A is located downstream of the supply unit 30A in the rotating direction R of the rotating body 10A outward in the radial direction C of the rotating body 10A. The flattening unit 50A extends in the center line direction D along the outer circumferential surface 14 of the rotating body 10A and has a length from the top surface 11A to the undersurface 12 in the center line direction D. The flattening unit 50A flattens slurry on the outer circumferential surface 14 of the rotating body 10A located inward in the radial direction C of the flattening unit 50A. When the outer circumferential surface 14 of the rotating body 10A located inward in the radial direction C of the flattening unit 50A is assumed to be a range U20, the flattening unit 50A flattens slurry on the outer circumferential surface 14 of the rotating body 10A in the range U20. Since the outer circumferential surface 14 of the rotating body 10A passes below the flattening unit 50A as the rotating body 10A rotates, the flattening unit 50A can flatten slurry at an arbitrary position of the outer circumferential surface 14 of the rotating body 10A. The flattening unit 50A flattens the slurry supplied from the supply unit 30A to the outer circumferential surface 14 of the rotating body 10A, and the one layer of the slurry layer 200 is thereby formed on the outer circumferential surface 14 of the rotating body 10A.

The relative drive unit 60A causes the supply unit 30A and the flattening unit 50A to relatively move in the radial direction C of the rotating body 10A with respect to the rotating body 10A. The relative drive unit 60A causes the rotating body 10A, and the supply unit 30A and the flattening unit 50A to move in such a way as to relatively come closer to or separate from each other along the radial direction C.

Of the relative drive unit 60A, the first drive unit 61A causes the head 31A of the supply unit 30A to move in the radial direction C with respect to the outer circumferential surface 14 of the rotating body 10A. For example, the first drive unit 61A causes the head 31A to move in the radial direction C in units of one layer of thickness. The first drive unit 61A is provided, for example, along the top surface 11A in the radial direction C. The first drive unit 61A is connected at an end portion of the head 31A and supports the head 31A so that the head 31A is located outward in the radial direction C on the outer circumferential surface 14 of the rotating body 10A. The first drive unit 61A causes the head 31A to supply slurry to the outer circumferential surface 14 of the rotating body 10A at a predetermined height.

Of the relative drive unit 60A, the second drive unit 62A causes the flattening unit 50A to move in the radial direction C with respect to the outer circumferential surface 14 of the rotating body 10A. For example, the second drive unit 62A causes the flattening unit 50A to move in the radial direction C in units of one layer of thickness. The second drive unit 62A is provided, for example, along the top surface 11A in the radial direction C. The second drive unit 62A is provided downstream of the first drive unit 61A in the rotating direction R of the rotating body 10A. The second drive unit 62A is connected at an end portion of the flattening unit 50A and supports the flattening unit 50A so that the flattening unit 50A is located outward in the radial direction C on the outer circumferential surface 14 of the rotating body 10A. The second drive unit 62A causes the flattening unit 50A to flatten slurry at a predetermined position with respect to the outer circumferential surface 14 of the rotating body 10A to form the slurry layer 200.

The irradiation unit 70 spot-radiates ultraviolet light at an irradiation position determined based on the shape of the molded object during rotation of the rotating body 10A by the rotation drive unit 20A. The “irradiation position” is a position at which the irradiation unit 70 irradiates the slurry supplied to the outer circumferential surface 14 of the rotating body 10A with ultraviolet light.

The irradiation unit 70 irradiates the outer circumferential surface 14 of the rotating body 10A located inward in the radial direction C of the irradiation unit 70 with ultraviolet light. For example, the irradiation unit 70 spot-radiates ultraviolet light in such a way as to scan on a line segment along the center line direction D from the outer circumference of the top surface 11A to the outer circumference of the undersurface 12 of the rotating body 10A. When the outer circumferential surface 14 of the rotating body 10A located inward in the radial direction C of the irradiation unit 70 is assumed to be a “range U30,” the irradiation unit 70 controls the light reflecting members 72 and 74, and the rotation small drive units 73 and 75 so that slurry on the outer circumferential surface 14 of the rotating body 10A in the range U30 can be irradiated with ultraviolet light.

Of the irradiation unit 70, at least the light reflecting member 74 and the rotation small drive unit 75 are provided outward in the radial direction C on the outer circumferential surface 14 of the rotating body 10A, and these components are located downstream of the flattening unit 50A in the rotating direction R of the rotating body 10A. The irradiation unit 70 is located, for example, within the range U30 and irradiates the slurry layer 200 flattened by the flattening unit 50A with ultraviolet light at the irradiation position. By irradiating the slurry layer 200 with ultraviolet light at the irradiation position during rotation of the rotating body 10A, the irradiation unit 70 forms a cross section corresponding to one layer of the molded object.

The controller 100A is hardware controlling the additive manufacturing apparatus 1A. The controller 100A is communicably connected to the rotation drive unit 20A, the supply unit 30A, the relative drive unit 60A and the irradiation unit 70. The controller 100A can have the same hardware configuration as that of the controller 100.

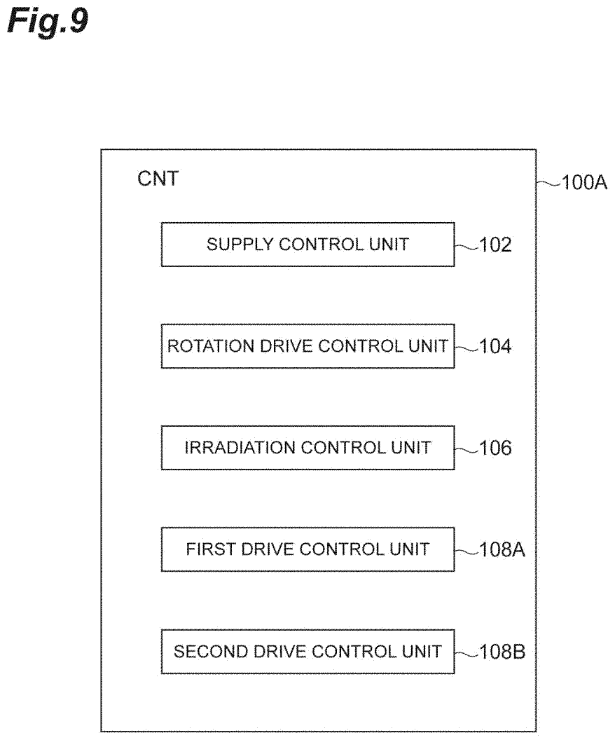

FIG. 9 is a block diagram illustrating an example of the controller of the additive manufacturing apparatus according to the second embodiment. As shown in FIG. 9, the controller 100 includes a supply control unit 102, a rotation drive control unit 104, an irradiation control unit 106, a first drive control unit 108A and a second drive control unit 108B. The supply control unit 102 controls an amount of slurry supplied by the supply unit 30A to the outer circumferential surface 14 of the rotating body 10A. The rotation drive control unit 104 controls the rotation drive unit 20A.

The irradiation control unit 106 controls the irradiation unit 70. The first drive control unit 108A controls the first drive unit 61A. The first drive control unit 108A controls a relative distance between the supply unit 30A and the rotating body 10A, and the speed and timing of causing the supply unit 30A and the rotating body 10A to relatively come closer to or separate from each other. The second drive control unit 108B controls the second drive unit 62A. The second drive control unit 108B controls a relative distance between the flattening unit 50A and the rotating body 10A, and the speed and timing of causing the flattening unit 50A and the rotating body 10A to relatively come closer to or separate from each other.

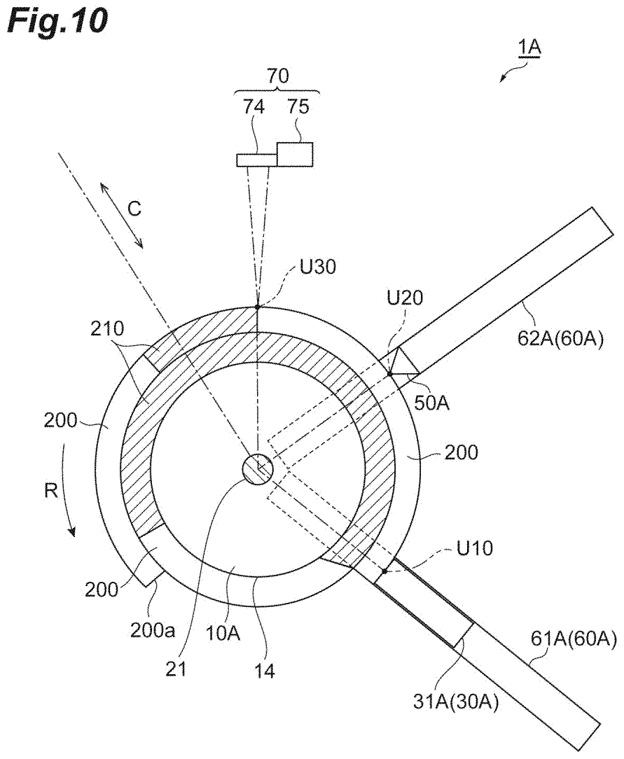

FIG. 10 is a view taken in the direction of arrows X-X in FIG. 8. As shown in FIG. 10, in the additive manufacturing apparatus 1A, the slurry layer 200 is laminated outward in the radial direction C. One surface of the molded object obtained by the additive manufacturing apparatus 1A becomes, for example, arcuate due to the shape of the outer circumferential surface 14. Operations and effects of the additive manufacturing method and the additive manufacturing apparatus 1A according to the second embodiment are the same as those of the additive manufacturing method MT and the additive manufacturing apparatus 1 according to the first embodiment when the radial direction C and the center line direction D are substituted.

### MODIFICATIONS

Various exemplary embodiments have been described so far, but various omissions, substitutions and changes can be made without being limited to the aforementioned exemplary embodiments. For example, the slurry according to the first embodiment and the second embodiment may include photosetting resin. In this case, the irradiation unit 70 radiates light.

The supply units 30 and 30A, the flattening units 50 and 50A, the relative drive units 60 and 60A, and the irradiation unit 70 according to the first embodiment and the second embodiment may be provided in plurality. In this case, an irradiation set composed of the supply units 30 and 30A, the flattening units 50 and 50A, the relative drive units 60 and 60A, and the irradiation unit 70 as one set is provided along the rotating direction R of the rotating bodies 10 and 10A.

A stage including a top surface to which slurry is supplied may be provided on the outer circumferential surface 14 of the rotating body 10A according to the second embodiment. The additive manufacturing apparatus 1A may be provided with a plurality of stages. In this case, the additive manufacturing apparatus 1A can form a molded object on each stage. The top surface of the stage may be flat. In this case, the distances in the radial direction C between the top surface of the stage and the supply unit 30A, the flattening unit 50A and the irradiation unit 70 are different distances. For this reason, the supply unit 30A may change the supply speed and the supply amount of slurry depending on the distances. The flattening unit 50A may change the length in the radial direction C of the end portion in contact with the flat surface of the stage depending on the rotation speed and the angle of rotation of the rotating body 10A. The irradiation unit 70 may change the layer formation height position depending on the rotation speed and the angle of rotation of the rotating body 10A.

The head 31 of the supply unit 30 of the first embodiment may be provided at the layer formation height position. The head 31A of the supply unit 30A according to the second embodiment may be separated from the outer circumferential surface 14 of the rotating body 10 in such a way as to have a height obtained by adding the thickness of the slurry layer 200 to the layer formation height position.

Furthermore, in the additive manufacturing apparatus 1 or 1A according to the first embodiment or the second embodiment, when flattening for a first layer of slurry and flattening for a second layer of slurry are performed sequentially in time, the flattening unit 50 or 50A needs to be moved in the direction away from the rotating body 10 or 10A by one layer at the timing of starting the flattening for the second layer of slurry. However, the movement of the flattening unit 50 or 50A takes time no matter how short it may be, and so there is a possibility that the flattening for the second layer of slurry may not be started at the intended timing depending on the rotation speed of the rotating body 10 or 10A. For this reason, the additive manufacturing apparatus 1 or 1A may perform control in such a way as to stop the rotation of the rotating body 10 or 10A at timing of starting the flattening for the second layer of slurry, move the flattening unit 50 or 50A in the direction away from the rotating body 10 or 10A by one layer, and then resume the rotation of the rotating body 10 or 10A.

Alternatively, the additive manufacturing apparatus 1 or 1A may include two flattening units 50 or 50A disposed in parallel. For example, the additive manufacturing apparatus 1 or 1A may include a flattening unit 50 or 50A on an upstream side and a flattening unit 50 or 50A on a downstream side. By moving the two flattening units 50 or 50A at different timings, the additive manufacturing apparatus 1 or 1A starts the flattening for the second layer of slurry at the intended timing. More specifically, the flattening unit 50 or 50A on the upstream side is disposed so that the end portion thereof becomes the height position of the upper layer 201 (second layer) of slurry and the flattening unit 50 or 50A on the downstream side is disposed so that the end portion thereof becomes the height position of the layer 200 (first layer) of slurry. In this case, the slurry supplied to the first layer is flattened by the flattening unit 50 or 50A on the upstream side to become the second layer. Using the time until the slurry which has become the second layer reaches the flattening unit 50 or 50A on the downstream side, the flattening unit 50 or 50A on the downstream side can move in the direction away from the rotating body 10 or 10A. In this way, the additive manufacturing apparatus 1 or 1A can perform the flattening for the second layer of slurry at the intended timing.

Alternatively, the flattening unit 50 or 50A may be configured to be movable in the rotating direction R of the rotating body 10. In this case, the additive manufacturing apparatus 1 or 1A can adjust a relative speed in the rotating direction R between the flattening unit 50 or 50A and the rotating body 10 or 10A. The additive manufacturing apparatus 1 or 1A can thereby relatively stop the rotation of the rotating body 10 or 10A when seen from the flattening unit 50 or 50A, at timing of starting the flattening for the second layer of slurry. In this way, the additive manufacturing apparatus 1 or 1A can eliminate a time lag between the timing of completing the movement for the flattening of the flattening unit 50 or 50A and the timing of starting flattening for the second layer of slurry.

The relative drive unit 60 according to the first embodiment may cause the top surface 11 of the rotating body 10 to move downward. In this case, neither the first drive unit 61 nor the second drive unit 62 has to be provided. The relative drive unit 60 may stop the rotation of the rotating body 10 by the rotation drive unit 20 and then move the top surface 11 of the rotating body 10 downward. When the rotation of the rotating body 10 by the rotation drive unit 20 is not stopped, the additive manufacturing apparatus 1 spirally supplies slurry to the top surface 11 of the rotating body 10.

The irradiation unit 70 according to the first embodiment or the second embodiment need not be provided with the light reflecting members 72 and 74. That is, the irradiation unit 70 may not have the function of changing the position of the irradiation point 70a and may directly irradiate the slurry layer 200 with ultraviolet light emitted from the optical unit 71. In this case, the additive manufacturing apparatus 1 or 1A may have a movement mechanism to move the optical unit 71 of the irradiation unit 70. For example, the additive manufacturing apparatus 1 according to the first embodiment has a movement mechanism to move the irradiation unit 70 in the radial direction C. The additive manufacturing apparatus 1A according to the second embodiment has a movement mechanism to move the irradiation unit 70 in the center line direction D. These movement mechanisms allow the irradiation unit 70 to irradiate the slurry layer 200 with ultraviolet light at all the irradiation positions 210.

In the second embodiment, the supply unit 30A, the flattening unit 50A and the irradiation unit 70 may be disposed in such a way that the higher the fluidity of slurry, the shorter the distance from the supply unit 30A to the irradiation unit 70 becomes. In the second embodiment, the supply unit 30A, the flattening unit 50A and the irradiation unit 70 may be provided above the axis of rotation M. In this case, the additive manufacturing apparatus 1A can prevent at least the part of the supplied slurry that becomes the molded object from being separated from the outer circumferential surface 14 due to gravity.

### DESCRIPTION OF THE NUMERALS

1, 1A . . . additive manufacturing apparatus, 10, 10A . . . rotating body, 11, 11A . . . top surface, 14 . . . outer circumferential surface, 20, 20A . . . rotation drive unit, 30, 30A . . . supply unit, 50, 50A . . . flattening unit, 60, 60A . . . relative drive unit, 61, 61A . . . first drive unit, 62, 62A . . . second drive unit, 70 . . . irradiation unit, 70a . . . irradiation point, 100, 100A . . . controller, 210 . . . irradiation position, C . . . radial direction, M . . . axis of rotation, MT . . . additive manufacturing method, R . . . rotating direction.

What is claimed is:

1. An additive manufacturing apparatus forming a molded object layer by layer, comprising:
a cylindrical rotating body having an axis of rotation in a direction along a center line thereof;
a rotation drive unit configured to cause the rotating body to rotate around the axis of rotation;
a supply unit provided above the rotating body and configured to supply slurry containing ultraviolet light curable resin to a top surface of the rotating body during rotation of the rotating body by the rotation drive unit;
a flattening unit provided above the rotating body, located downstream of the supply unit in a rotating direction of the rotating body and configured to flatten the slurry supplied to the top surface of the rotating body at an end portion thereof to a thickness corresponding to one layer during rotation of the rotating body by the rotation drive unit;
a relative drive unit configured to relatively move the rotating body with respect to the supply unit and the flattening unit in the direction along the center line of the rotating body; and
an irradiation unit provided above the rotating body, located downstream of the flattening unit in the rotating direction of the rotating body and configured to perform spot-irradiation with ultraviolet light at an irradiation position determined based on a shape of the molded object during rotation of the rotating body by the rotation drive unit.

2. The additive manufacturing apparatus according to claim 1, wherein the irradiation unit completes irradiation corresponding to one layer of the molded object after irradiation with ultraviolet light starts until the rotating body makes one rotation based on a rotation speed of the rotating body by the rotation drive unit and the irradiation position.

3. The additive manufacturing apparatus according to claim 1, wherein the irradiation unit changes an ultraviolet light irradiation position based on a rotation speed of the rotating body by the rotation drive unit and the irradiation position for every rotation of the rotating body along a radial direction of the rotating body and completes irradiation corresponding to one layer of the molded object.

4. An additive manufacturing apparatus forming a molded object layer by layer, comprising:
a cylindrical rotating body having an axis of rotation in a direction along a center line thereof;
a rotation drive unit configured to cause the rotating body to rotate around the axis of rotation;
a supply unit provided outside the rotating body and configured to supply slurry containing ultraviolet light curable resin to an outer circumferential surface of the rotating body during rotation of the rotating body by the rotation drive unit;
a first drive unit configured to move the supply unit along a radial direction of the rotating body;
a flattening unit provided outside the rotating body, located downstream of the supply unit in the rotating direction of the rotating body and configured to flatten the slurry supplied to the outer circumferential surface of the rotating body at an end portion thereof to a thickness corresponding to one layer during rotation of the rotating body by the rotation drive unit;
a second drive unit configured to move the flattening unit along the radial direction of the rotating body; and
an irradiation unit provided outside the rotating body, located downstream of the flattening unit in the rotating direction of the rotating body and configured to perform spot-irradiation with ultraviolet light at an irradiation position determined based on a shape of the molded object during rotation of the rotating body by the rotation drive unit.

5. The additive manufacturing apparatus according to claim 4, wherein the irradiation unit completes irradiation corresponding to one layer of the molded object after irradiation with ultraviolet light starts until the rotating body makes one rotation based on a rotation speed of the rotating body by the rotation drive unit and the irradiation position.

6. The additive manufacturing apparatus according to claim 4, wherein the irradiation unit changes an ultraviolet light irradiation position based on a rotation speed of the rotating body by the rotation drive unit and the irradiation position for every rotation of the rotating body along the center line of the rotating body and completes irradiation corresponding to one layer of the molded object.

7. An additive manufacturing method forming a molded object layer by layer, comprising:
rotating a cylindrical rotating body having an axis of rotation in a direction along a center line thereof around the axis of rotation;
supplying slurry containing ultraviolet light curable resin to a top surface of the rotating body during rotation of the rotating body;
flattening the slurry supplied to the top surface of the rotating body in the supplying to a thickness corresponding to one layer during rotation of the rotating body; and
spot-irradiating the slurry flattened on the top surface of the rotating body in the flattening with ultraviolet light at an irradiation position determined based on a shape of the molded object during rotation of the rotating body.

8. An additive manufacturing method forming a molded object layer by layer, comprising:
rotating a cylindrical rotating body having an axis of rotation in a direction along a center line thereof around the axis of rotation;
supplying slurry containing ultraviolet light curable resin to an outer circumferential surface of the rotating body during rotation of the rotating body;
flattening the slurry supplied to the outer circumferential surface of the rotating body in the supplying to a thickness corresponding to one layer during rotation of the rotating body; and
spot-irradiating the slurry flattened on the outer circumferential surface of the rotating body in the flattening with ultraviolet light at an irradiation position determined based on a shape of the molded object during rotation of the rotating body.
